(19) United States
(12) Patent Application Publication
(10) Pub. No.: US 2022/0200852 A1
(43) Pub. Date: Jun. 23, 2022

(54) DEVICE MANAGEMENT SYSTEM, DEVICE MANAGEMENT APPARATUS, DEVICE MANAGEMENT METHOD, AND DEVICE MANAGEMENT PROGRAM

(71) Applicant: KYOCERA Corporation, Kyoto (JP)

(72) Inventors: Tomohiro SUDOU, Yokohama-shi, Kanagawa (JP); Shinya MIZUNO, Machida-shi, Tokyo (JP)

(73) Assignee: KYOCERA Corporation, Kyoto (JP)

(21) Appl. No.: 17/601,501

(22) PCT Filed: Mar. 27, 2020
(86) PCT No.: PCT/JP2020/014022

§ 371 Date: Oct. 5, 2021

(30) Foreign Application Priority Data
Apr. 16, 2019 (JP) 2019-078024

(51) Int. Cl. H04L 41/0806; H04L 41/0823; H04W 4/02; H04W 4/50

(52) U.S. Cl. CPC H04L 41/0806; H04W 4/50; H04W 4/027; H04L 41/0823

(57) ABSTRACT

A device management system for configuring a configuration target device includes: a candidate determiner configured to determine, from among a plurality of installed devices, based on position information of each of the plurality of installed devices and position information of the configuration target device, a candidate device of a reference device to be referred to for configuring the configuration target device; a reference device selector configured to select the reference device from among a plurality of the candidate devices determined by the candidate determiner, based on a device operation on the configuration target device; and a configuration processor configured to perform a process of configuring, for the configuration target device, configuration information configured for the reference device selected by the reference device selector.

### TECHNICAL FIELD

The present disclosure relates to a device management system, a device management apparatus, a device management method, and a device management program.

### BACKGROUND ART

Patent Document 1 describes a management apparatus configured to receive, from a first device newly installed, identification information of a second device located within a predetermined range from the first device, retrieve installation position corresponding to the received identification information from a database, and estimate and display the installation position of the first device based on the retrieved installation position of the second device.

### CITATION LIST

### Patent Document

Patent Document 1: Japanese Application Publication No. 2005-312017

### SUMMARY OF INVENTION

A device management system according to a first aspect is a system including at least one processor to configure a configuration target device. The at least one processor is configured to perform: a candidate determination process of determining, from among a plurality of installed devices, based on position information of each of the plurality of installed devices and position information of the configuration target device, a candidate device which is a candidate of a reference device to be referred to for configuring the configuration target device; a reference device selection process of selecting the reference device from among a plurality of the candidate devices determined in the candidate determination process, based on a device operation on the configuration target device; and a configuration process of configuring, for the configuration target device, configuration information configured for the reference device selected in the reference device selection process.

A device management apparatus according to a second aspect is a device to configure a configuration target device. The device management apparatus includes a controller configured to perform: a candidate determination process of determining, from among a plurality of installed devices, based on position information of each of the plurality of installed devices and position information of the configuration target device, a candidate device which is a candidate of a reference device to be referred to for configuring the configuration target device; a reference device selection process of selecting the reference device from among a plurality of the candidate devices determined in the candidate determination process, based on a device operation on the configuration target device; and a configuration process of configuring, for the configuration target device, configuration information configured for the reference device selected by the reference device selection process.

A device management method according to a third aspect is a method for configuring a configuration target device. The device management method includes: determining, from among a plurality of installed devices, based on position information of each of the plurality of installed devices and position information of the configuration target device, a candidate device which is a candidate of a reference device to be referred to for configuring the configuration target device; selecting the reference device from among a plurality of the candidate devices determined, based on a device operation on the configuration target device; and performing a process of configuring, for the configuration target device, configuration information configured for the selected reference device.

The device management program according to a fourth aspect causes the computer to perform the device management method according to the third aspect.

### BRIEF DESCRIPTION OF DRAWINGS

FIG. 1 illustrates an example configuration of a device management system according to one embodiment;

FIG. 2 illustrates an example operation of a device management apparatus in a second scenario according to one embodiment;

FIG. 3 illustrates a device management system according to another example configuration;

FIG. 4 illustrates a configuration of a communication device according to one embodiment;

FIG. 5 illustrates a configuration of a device management apparatus according to one embodiment;

FIG. 6 illustrates installation device information according to one embodiment;

FIG. 7 illustrates an example of a first pattern of an operation of a candidate determiner according to one embodiment;

FIG. 8 illustrates another example of the first pattern of the operation of the candidate determiner according to one embodiment;

FIG. 9 illustrates an example of a second pattern of the operation of the candidate determiner according to one embodiment;

FIG. 10 illustrates an example operation of a device management apparatus according to one embodiment;

FIG. 11 illustrates a specific example of a device configuration operation according to one embodiment;

FIG. 12 illustrates a specific example of a configuration change operation according to one embodiment; and

FIG. 13 illustrates an example change of the system configuration illustrated in FIG. 3.

### DESCRIPTION OF EMBODIMENTS

In recent years, as the Internet of Things (IoT) technology is widely used, there is expected an explosive increase of devices with communication functions. Such devices may require various types of configurations at the time of installation.

However, manually inputting configuration information for each device by a user not only requires a large amount of labor, but may also give rise to a concern such that the device may not operate as intended due to an input error or the like of the configuration information.

The present disclosure therefore allows for efficiently performing a configuration process on devices.

Embodiments will be described with reference to the drawings. In the description of the drawings, the same or similar parts are given the same or similar reference numerals.

### Example System Configuration

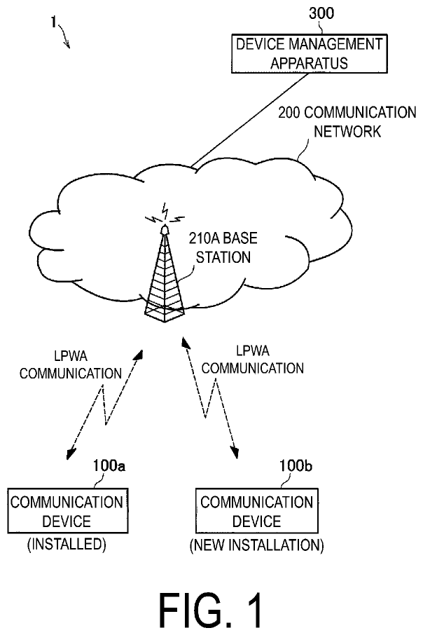

FIG. 1 illustrates an example configuration of a device management system 1 according to one embodiment.

As illustrated in FIG. 1, the device management system 1 has a plurality of communication devices 100 (communication devices 100a and 100b), a communication network 200, and a device management apparatus 300.

The communication devices 100 are devices each having a communication function. The communication devices 100 are, for example, sensor devices each having various sensors and perform communication via the communication network 200 to transmit measurement information acquired by the various sensors.

The communication devices 100 perform Low Power Wide Area (LPWA) wireless communication with the communication network 200. LPWA is a wireless communication scheme that realizes long-range communication while suppressing power consumption.

LPWA includes, for example, cellular LPWA, SIGFOX, or LoRaWAN. Cellular LPWA may be enhanced Machine Type Communications (eMTC) or Narrow Band-Internet of Things (NB-IoT) defined in the 3^{rd} generation partnership project (3GPP) standard.

The communication devices 100 may be installed outdoors or indoors. In a case where the communication devices 100 are installed outdoors, the communication devices 100 are driven by a battery provided in each device. In a case where the communication devices 100 are installed indoors, the communication devices 100 may be driven by power supplied from a battery provided in each device or may be driven by power supplied from a commercial power source (AC power source).

The communication network 200 includes a base station 210A configured to perform wireless communication with the communication devices 100, and a high-frequency communication network (Wide Area Network (WAN)). The communication network 200 may further include the Internet.

The device management apparatus 300 is a server connected to the communication network 200. The device management apparatus 300 manages the communication devices 100 by communicating with the communication devices 100 via the communication network 200.

The device management apparatus 300 does not necessarily have to be a dedicated server. The device management apparatus 300 may be a general-purpose terminal (e.g., smartphone or PC) having a device management application program installed therein.

In one embodiment, there is assumed a scenario of newly installing the communication device 100b under a condition that the communication device 100a has previously been installed. The communication device 100a corresponds to a installed device, and the communication device 100b corresponds to a configuration target device.

The first scenario is a scenario that replaces the communication device 100a (exchanges) with the communication device 100b. For example, when a battery of the communication device 100a has failed or needs an exchange, the installed communication device 100a is removed, and the new communication device 100b is installed at an installation position at which the communication device 100a had been installed. Removal of the communication device 100a refers to moving the communication device 100a from the installation position of the communication device 100a to another position.

The second scenario is a scenario that additionally installs the new communication device 100b, while maintaining the communication device 100a after the communication device 100a has been installed. For example, the communication device 100b is newly installed in the vicinity of the installed communication device 100a in order to two-dimensionally cover the area to be measured (e.g., field or factory).

In the first and the second scenarios, the device management apparatus 300 initially receives, from the communication device 100a, first position information indicating the installation position of the installed communication device 100a and receives, from the communication device 100b, second position information indicating the current position of the communication device 100b to be newly installed. Here, “installation position of the communication device 100a” refers to the position at which the communication device 100a had been installed in the past, or the position at which the communication device 100a is currently installed.

Here, when using the communication devices 100 outdoors, the position information (the first and the second position information, respectively) may include the Global Navigation Satellite System (GNSS) position information.

When, on the other hand, using the communication devices 100 indoors, signals from the GNSS satellite may not reach the communication devices 100, and therefore the position information may include information related to the surrounding environment of the communication devices 100. For example, when using the communication devices 100 indoors, the position information (the first and the second position information, respectively) may include at least one of: wireless LAN received signal strength, proximity sensor measurement information, magnetic field sensor measurement information, atmospheric pressure sensor measurement information, and an external apparatus being the destination of wireless connection.

Next, the device management apparatus 300 determines whether or not the communication device 100b is located within a predetermined range from the installation position of the communication device 100a, based on the first and the second position information. The phrase “the communication device 100b is located within a predetermined range from the installation position of the communication device 100a” states that the communication device 100b is located at the same position as the installation position of the communication device 100a or in the vicinity of the installation position of the communication device 100a. Here, the phrase “the same position as the installation position of the communication device 100a” is intended to also include a position that can be regarded as the same as the installation position of the communication device 100a, taking into account measurement error (measurement precision) of the position information.

Next, upon determining that the communication device 100b is located within a predetermined range from the installation position of the communication device 100a, the device management apparatus 300 transmits the same configuration information as the configuration information applied to the communication device 100a to the communication device 100b. In other words, the communication device 100b receives, from the device management apparatus 300, the same configuration information as the configuration information applied to the communication device 100a which had been located at the position of the communication device 100b or the communication device 100a located in the vicinity of the communication device 100b. Subsequently, the communication device 100b stores the configuration information received from the device management apparatus 300, and controls operation of the communication device 100b based on the stored configuration information.

As a result, the first and the second scenarios allow the configuration information of the communication device 100a to be referred to (applied) as the configuration information of the communication device 100b to be newly installed. Therefore, it is possible to reduce the user's labor and also prevent occurrence of input errors or the like of the configuration information, in comparison with the case where the user manually inputs the configuration information of the communication device 100b.

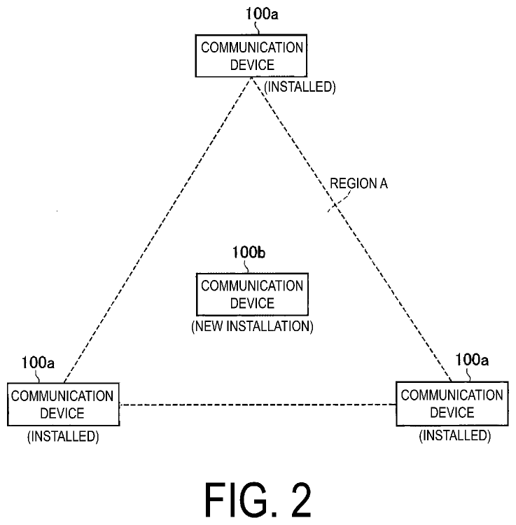

In the second scenario of adding the new communication device 100b to the installed communication device 100a in order to two-dimensionally cover the area to be measured (e.g., field or factory), the device management apparatus 300 may perform an operation as described below. FIG. 2 illustrates an example operation of the device management apparatus 300 in the second scenario.

As illustrated in FIG. 2, when there are three or more installed communication devices 100a, the device management apparatus 300 initially receives first position information from each of the three or more communication devices 100a, and receives second position information from the new communication device 100b.

Next, in a case where the configuration information applied to the three or more communication devices 100a are identical, the device management apparatus 300 determines, based on respective first position information of each of the three or more communication devices 100a, and the second position information, whether or not the new communication device 100b is located within a polygonal region (region A) whose apexes are respective installation positions of each of the three or more communication devices 100a.

Upon determining that the communication device 100b is located within the region A, the device management apparatus 300 transmits, to the new communication device 100b, the same configuration information as the configuration information applied to the three or more communication devices 100a. As a result, the new communication device 100b is configured with the same configuration information as the configuration information applied to the three or more communication devices 100a.

Here, FIG. 2 illustrates an example with three installed communication device 100a. For example, in a case where the area of the object to be measured is triangular, the communication devices 100a (three in all) are initially installed near each apex of the triangular area. Next, the new communication devices 100b are additionally installed inside the triangular area in sequence. In this case, although manual configuration is required when installing the three communication devices 100a, configuration of all the new communication devices 100b is performed automatically.

When, alternatively, the area to be measured is quadrangular, the communication devices 100a (four in all) are initially installed near each apex of the quadrangular area. Next, the new communication devices 100b are additionally installed inside the quadrangular area in sequence. In this case, although manual configuration is required when installing the four communication devices 100a, configuration of all the new communication devices 100b is performed automatically.

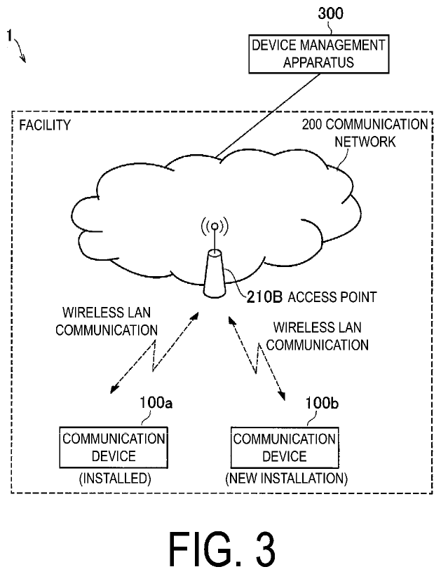

Note that, in a case where the communication devices 100 are installed indoors and have wireless LAN communication function, the communication devices 100 may perform wireless LAN communication with an access point installed indoors, instead of LPWA communication. FIG. 3 illustrates a device management system 1 according to another example configuration.

As illustrated in FIG. 3, the communication devices 100 are installed within a facility (indoors). The facility is a factory or a residence, for example. The communication devices 100 perform wireless LAN communication with an access point 210B included in the communication network 200 within the facility. The device management apparatus 300 manages the communication devices 100 by communicating with the communication devices 100 via the communication network 200 (access point 210B).

### Example Configuration of Communication Device

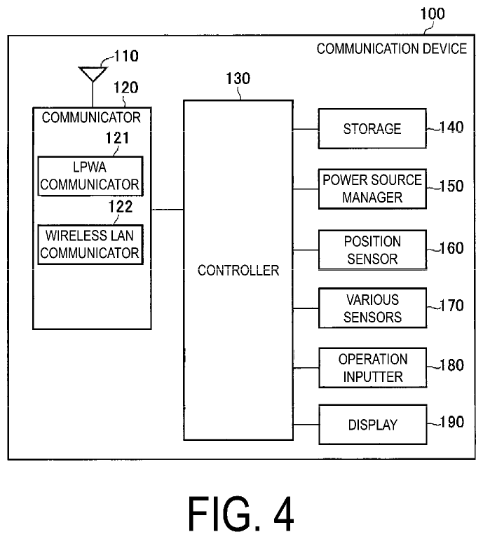

FIG. 4 illustrates a configuration of the communication device 100 according to one embodiment.

As illustrated in FIG. 4, the communication device 100 has an antenna 110, a communicator 120, a controller 130, a storage 140, a power source manager 150, a position sensor 160, various sensors 170, an operation inputter 180, and a display 190.

The antenna 110 is used to transmit and receive wireless signals. The communicator 120 performs communication with the device management apparatus 300 via the communication network 200. In one embodiment, the communicator 120 includes an LPWA communicator 121 configured to perform LPWA communication with the base station 210A included in the communication network 200 and/or a wireless LAN communicator 122 configured to perform wireless LAN communication with the access point 210B included in the communication network 200.

The LPWA communicator 121 and the wireless LAN communicator 122 perform processes such as amplification and filtering of a wireless signal which the antenna 110 receives from the base station 210A, convert the wireless signal into a baseband signal, and output the converted signal to the controller 130. The LPWA communicator 121 and the wireless LAN communicator 122 convert the baseband signal input from the controller 130 into a wireless signal, performs an amplification process or the like thereon, and transmit the resulting signal from the antenna 110.

The controller 130 performs various processes and controls in the communication device 100. For example, the controller 130 controls the communicator 120 to perform communication with the device management apparatus 300 via the communication network 200. The controller 130 may control the position sensor 160 to periodically acquire position information, and control the communicator 120 to periodically transmit (upload) the position information to the device management apparatus 300. The controller 130 includes at least one processor. The processor may include a baseband processor and a Central Processing Unit (CPU). The baseband processor performs modulation and demodulation, and coding and decoding of a baseband signal, and the like. The CPU executes programs stored in the storage 140 to perform various processes.

The storage 140 includes a volatile memory and a non-volatile memory. The storage 140 stores programs to be executed by the controller 130 and information to be used in processes by the controller 130.

The storage 140 stores configuration information for configuring functions and operations of the communication device 100 under control of the controller 130.

For example, the configuration information includes information for configuring the transmission timing of the measurement information acquired by the various sensors 170 (at least one sensor). The information may be information for configuring the time point (e.g., 10 o'clock, 14 o'clock, and/or 18 14 o'clock) or time period (e.g., 12 hours, and/or 24 hours) to upload the measurement information acquired by the various sensors 170 to the device management apparatus 300 or another server. At a timing determined according to the configuration information, the controller 130 uploads the measurement information acquired by the various sensors 170 via the communicator 120.

In addition, the configuration information includes information for configuring a sensor to be enabled or disabled among the various sensors 170 (a plurality of sensors). In other words, the information is information for configuring the type of measurement information to be uploaded to the device management apparatus 300 or another server. For example, in a case where the various sensors 170 include a temperature sensor, a humidity sensor, an atmospheric pressure sensor, a magnetic field sensor (geomagnetic sensor), and an acceleration sensor, temperature and humidity are configured as the measurement information to be uploaded. In this case, the controller 130 enables (turns on) the humidity sensor and the atmospheric pressure sensor based on the configuration information, and disables (turns off) the atmospheric pressure sensor, the magnetic field sensor, and the acceleration sensor.

Furthermore, the configuration information may include a program to be executed by the controller 130. The program may be a control program (firmware), or an application program.

In addition, the storage 140 has preliminarily stored therein the address (e.g., IP address) of the device management apparatus 300, allowing the communication device 100 to access the device management apparatus 300. Furthermore, the storage 140 has preliminarily stored therein device identification information (device ID) for identifying the device.

The power source manager 150 includes a battery and peripheral circuitry thereof. The power source manager 150 supplies driving power of the communication device 100. Here, in a case where the communication device 100 receives power supply from the outside, the power source manager 150 may include a circuit configured to convert the power supplied from the outside.

The position sensor 160 is a sensor for acquiring position information indicating the current position of the communication device 100. For example, the position sensor 160 is configured to include a GNSS receiver. The GNSS receiver may include a Global Positioning System (GPS) receiver, a Global Navigation Satellite System (GLONASS) receiver, an Indian Regional Navigational Satellite System (IRNSS) receiver, a COMPASS receiver, a Galileo receiver, and/or a QZSS Satellites System receiver, or the like. The position sensor 160 acquires position information under control of the controller 130, and outputs the acquired position information (GNSS position information) to the controller 130.

The various sensors 170 include an acceleration sensor configured to detect an acceleration added to the communication device 100. The various sensors 170 may include at least one of: a temperature sensor, a humidity sensor, an atmospheric pressure sensor, a magnetic field sensor (geomagnetic sensor), an illuminance sensor, and a proximity sensor. The various sensors 170 may include an image sensor for acquiring images via image capturing. The various sensors 170 perform measurement under control of the controller 130, and output measurement information acquired by the measurement to the controller 130.

The various sensors 170 include a sensor configured to detect the orientation of the communication device 100. Although a multi-axis acceleration sensor and/or a geomagnetic sensor, for example, can be used as such a sensor, any sensor may be used that can detect the orientation of the communication device 100 may be used.

The operation inputter 180 receives user operation and outputs a signal indicating specifics of the operation to the controller 130. For example, the operation inputter 180 includes a power switch for powering on or shutting down the communication device 100. The operation inputter 180 may include various keys (various buttons) configured to accept manual input of configuration information.

The display 190 performs various types of transmission under control of the controller 130. The display 190 includes an indicator configured to display the current state of the communication device 100. The indicator includes an LED, for example. The display 190 may include a display such as a liquid crystal display, an organic EL display, or an electronic paper. Here, the communication device 100 may have an audio outputter (speaker) instead of, or in addition to, the display 190.

### Example Configuration of Device Management Apparatus

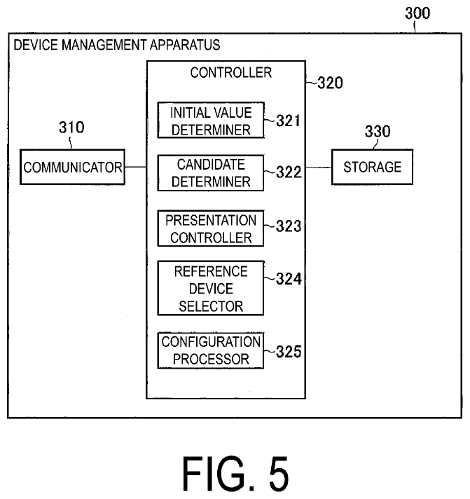

FIG. 5 illustrates a configuration of the device management apparatus 300 according to one embodiment.

As illustrated in FIG. 5, the device management apparatus 300 includes a communicator 310, a controller 320, and a storage 330.

The communicator 310 receives position information and measurement information from the communication devices 100. The communicator 310, being configured to include a wired communication module or a wireless communication module, performs communication with the communication devices 100 via the communication network 200. The wireless communication module may be a Bluetooth (registered trademark, referred to as “BT” below) communication module, or a wireless LAN communication module.

The controller 320 performs various processes and controls in the device management apparatus 300. For example, the controller 320 controls the communicator 310 to perform communication with the communication devices 100 via the communication network 200. The controller 320 may include at least one processor. The processor executes programs stored in the storage 330 to perform various processes.

The storage 330 includes a volatile memory, a non-volatile memory, and an auxiliary storage device (such as a hard disk). The storage 330 stores programs to be executed by the controller 320, and information to be used for processing by the controller 320.

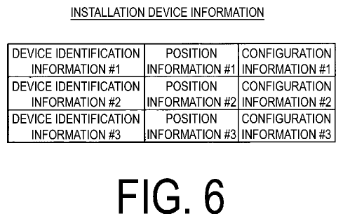

For example, the storage 330 stores installation device information such as that illustrated in FIG. 6. The controller 320 manages installation device information stored in the storage 330. As illustrated in FIG. 6, the installation device information includes, for each of the installed communication devices 100a, device identification information (device ID) for identifying the communication device 100, position information (first position information) indicating the installation position of the communication device 100a, and configuration information applied to the communication device 100a.

The controller 320 may add, to the installation device information, information corresponding to the communication device 100 when the communication device 100b to be newly installed is detected and after configuration has been completed for the communication device 100b to be newly installed. In addition, even having detected that the installed communication device 100a has been removed, the controller 320 may hold the information corresponding to the removed communication device 100a in the installation device information.

The controller 320 performs a process of configuring the new communication device 100b, which is the configuration target device. In one embodiment, the controller 320 executes programs stored in the storage 330 to configure an initial value determiner 321, a candidate determiner 322, a presentation controller 323, a reference device selector 324, and a configuration processor 325.

The initial value determiner 321 determines whether or not the configuration information applied to the new communication device 100b is an initial value. For example, the initial value determiner 321 receives a notification indicating whether or not the configuration information is the initial value from the new communication device 100b via the communicator 310, and performs determination based on the notification. In a case where the configuration information other than the initial value has been applied to the new communication device 100b by the user or the like, the configuration information is prioritized, so as not to refer to the configuration information of the installed communication device 100a.

The candidate determiner 322 determines, from among the installed communication devices 100a, based on the position information (first position information) of each of the installed communication devices 100a and the position information (second position information) of the new communication device 100b,

candidate devices of a reference device to be referred to when configuring the new communication device 100b. The pattern for determining candidate devices includes the two patterns described below, for example.

In the first pattern, the candidate determiner 322 determines the installed communication device 100a located closest to the new communication device 100b as a first candidate device. In addition, the candidate determiner 322 determines the installed communication device 100a which is different from the first candidate device as a second candidate device having a lower priority than the first candidate device.

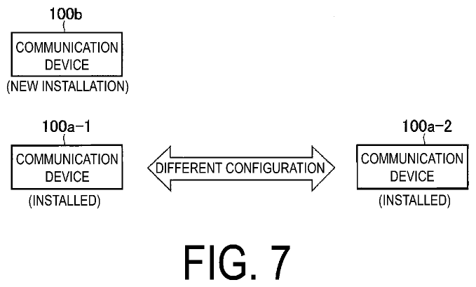

FIG. 7 illustrates an example of the first pattern. As illustrated in FIG. 7, there are installed communication devices 100a-1 and 100a-2 configured differently from each other. The new communication device 100b, having an initial value applied thereto as the configuration information, is powered-on in the vicinity of the installed communication device 100a-1.

In the example illustrated in FIG. 7, the candidate determiner 322 determines the installed communication device 100a-1 located closest to the new communication device 100b as the first candidate device, and determines the installed communication device 100a-2 as the second candidate device.

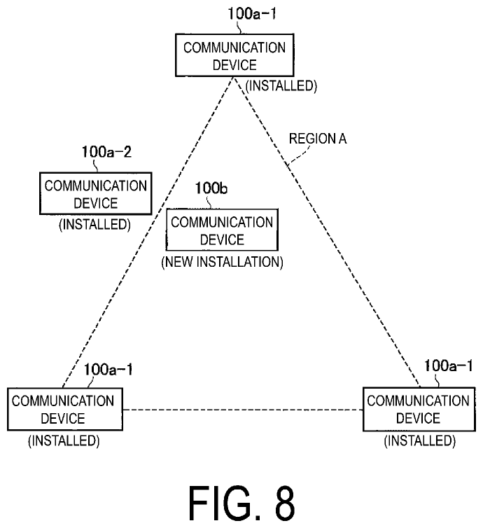

FIG. 8 illustrates another example of the first pattern. As illustrated in FIG. 8, there are a plurality of installed communication devices 100a-1 and a installed communication device 100a-2 configured differently from the installed communication devices 100a-1. The plurality of installed communication devices 100a-1 form a region A including the position of the new communication device 100b. The new communication device 100b, having an initial value applied thereto as the configuration information, is powered-on in the vicinity of the installed communication device 100a-2.

In the example illustrated in FIG. 8, the candidate determiner 322 determines the installed communication device 100a-2 located closest to the new communication device 100b as the first candidate device, and determines the installed communication device 100a-1 as the second candidate device.

On the other hand, in the second pattern, the candidate determiner 322 determines, as the first candidate device, the installed communication devices 100a included in a first device group forming a first region including the position of the new communication device 100b, and being configured identically to each other. In addition, the candidate determiner 322 determines, as the second candidate device, the installed communication device 100a included in a second device group forming a second region including the position of the new communication device 100b, and being configured identically to each other. Here, the first device group is a device group including the installed communication device 100a located closest to the new communication device 100b.

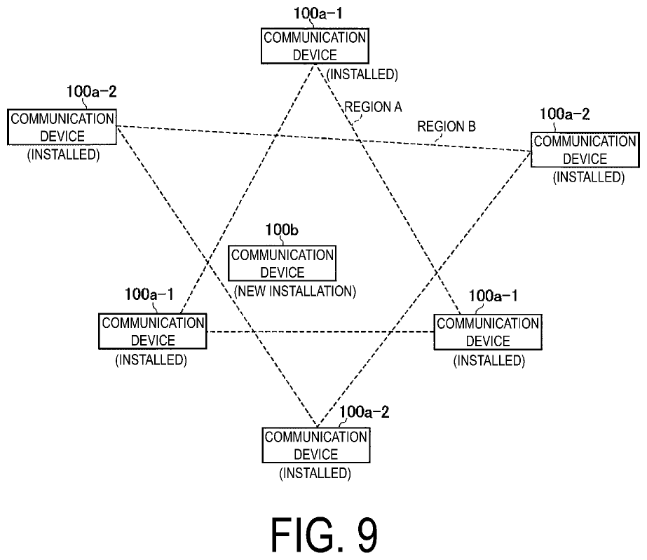

FIG. 9 illustrates an example of a second pattern. As illustrated in FIG. 9, there exist a plurality of installed communication devices 100a-1 (first device group) and a plurality of installed communication devices 100a-2 (second device group) configured differently from the communication devices 100a-1. The plurality of installed communication devices 100a-1 form a region A including the position of the new communication device 100b. The plurality of installed communication devices 100a-2 form a region B including the position of the new communication device 100b. The new communication device 100b, having an initial value applied thereto as the configuration information, is powered on in the vicinity of the installed communication device 100a-1.

In the example illustrated in FIG. 9, the candidate determiner 322 determines the installed communication device 100a-1 as the first candidate device, and determines the installed communication devices 100a-2 as the second candidate device.

After the candidate device has been determined by the candidate determiner 322, the presentation controller 323 causes at least one of the first candidate device and the new communication device 100b to present the first information indicating that the first candidate device is selected as the reference device. Here, “presentation” refers to at least one of display or audio output.

For example, the first information may be a predetermined color. The presentation controller 323 transmits, to the first candidate device via the communicator 310, an instruction that causes the display 190 (indicator) of the first candidate device to emit light of a predetermined color. The first candidate device, in response to the instruction, causes the display 190 (indicator) to emit light of a predetermined color. Accordingly, the user can check which configuration information of the communication devices 100a is to be applied to the new communication device 100b.

In addition, the presentation controller 323 may transmit, to the new communication device 100b via the communicator 310, an instruction that causes the display 190 (indicator) of the new communication device 100b to emit light of a predetermined color. The new communication device 100b, in response to the instruction, causes the display 190 (indicator) to emit light of a predetermined color. Here, the presentation controller 323 may cause the first candidate device and the new communication device 100b to emit light of a same color. Note that the first candidate device and the new communication device 100b may use not only an identical light emission color but also an identical light emission pattern (time interval of light emission).

Alternatively, the presentation controller 323 may cause the new communication device 100b to display the device ID of the first candidate device. However, there may be a case where a user of the new communication device 100b is not aware of the device ID of the first candidate device. Therefore, it may be intuitively easier for the user that the presentation controller 323 uses the display (light emission) of the first information as described above.

The first information may be a predetermined sound. The presentation controller 323 may transmit, to the first candidate device via the communicator 310, an instruction that causes an audio outputter of the first candidate device to output a predetermined sound. In response to the instruction, the first candidate device causes the audio outputter of the first candidate device to output a predetermined sound.

The reference device selector 324 selects, from among the candidate devices determined by the candidate determiner 322 based on the device operation performed on the new communication device 100b, a reference device to be referred to when configuring the new communication device 100b.

In a case where any first device operation is not detected for a certain time period after presentation of the first information has been started, the reference device selector 324 determines that the user desires the configuration information of the first candidate device to be applied to the new communication device 100b, and selects the first candidate device as the reference device.

Here, the first device operation may be an operation of changing the orientation of the new communication device 100b. The reference device selector 324 acquires, via the communicator 310, measurement information acquired by the sensor of the new communication device 100b, and identifies the orientation and its change of the new communication device 100b.

Alternatively, the first device operation may be an operation of pressing a predetermined button provided on the new communication device 100b. However, the communication device such as a sensor device provided with poor user interface may have only a power button, for example. In such a case, it is preferred to consider the change of orientation as the first device operation.

On the other hand, in a case where a first device operation is detected within a certain time period, the presentation controller 323 determines that the user does not desire the configuration information of the first candidate device to be applied to the new communication device 100b. Subsequently, the presentation controller 323 causes at least one of the second candidate device and the new communication device 100b to present the second information indicating that the second candidate device is selected as the reference device.

For example, the second information may be a predetermined color. The presentation controller 323 transmits, to the second candidate device via the communicator 310, an instruction that causes the display 190 (indicator) of the second candidate device to emit light of a predetermined color. The second candidate device, in response to the instruction, causes the display 190 (indicator) to emit light of a predetermined color.

In addition, the presentation controller 323 may transmit, to the new communication device 100b via the communicator 310, an instruction that causes the display 190 (indicator) of the new communication device 100b to emit light of a predetermined color. In response to the instruction, the new communication device 100b causes the display 190 (indicator) to emit light of a predetermined color. Here, the presentation controller 323 may cause the second candidate device and the new communication device 100b to emit light of a same color. Note that the second candidate device and the new communication device 100b may emit light according to a same light emission pattern (time interval of light emission), without the second candidate device and the new communication device 100b being limited to emit light of a same color.

Alternatively, the presentation controller 323 may cause the new communication device 100b to display the device ID of the second candidate device. However, there may be a case where a user of the new communication device 100b is not aware of the device ID of the second candidate device. Therefore, it may be intuitively easier for the user that the presentation controller 323 uses the display (light emission) of the second information as described above.

The second information may be a predetermined sound. The presentation controller 323 may transmit, to the second candidate device via the communicator 310, an instruction that causes the audio outputter of the second candidate device to output a predetermined sound to the second candidate device. The second candidate device, in response to the instruction, cause the audio outputter of the second candidate device to output a predetermined sound.

In a case where a first device operation is not detected for a certain time period after presentation of the second information has been started, the reference device selector 324 determines that the user wants the configuration information of the second candidate device to be applied to the new communication device 100b, and selects the second candidate device as the reference device.

Note that, in a case where a first device operation is detected within a certain time period after presentation of the second information has been started, the presentation controller 323 may redo the process. In other words, the presentation controller 323 causes at least one of the first candidate device and the new communication device 100b to present the first information indicating that the first candidate device is selected as the reference device.

Alternatively, in a case where the first device operation is detected within a certain time period after the presentation of the second information has been started, and configuration information other than the initial value is applied to the new communication device 100b, the reference device selector 324 determines that the user desires to use the configuration information. Subsequently, the presentation controller 323 may cause the new communication device 100b to present third information indicating that the configuration information is used. The third information may be a predetermined color or a predetermined sound.

The configuration processor 325 performs a process of configuring, for the new communication device 100b, the configuration information configured for the reference device selected by the reference device selector 324. For example, in a case where the second candidate device has been selected as the reference device, the configuration processor 325 transmits, to the new communication device 100b via the communicator 310, the configuration information applied to the second candidate device. The new communication device 100b stores the received configuration information.

Alternatively, in a case where the communication devices 100 support direct inter-device communication, the following configuration process may be performed. Here, direct inter-device communication is intended to be Bluetooth communication. Initially, the configuration processor 325 transmits, to the communication device 100a, an instruction to transmit the configuration information to the communication device 100b via Bluetooth communication. Next, the communication device 100a transmits the configuration information to the communication device 100b in response to the instruction. Subsequently, the communication device 100b performs configuration based on the configuration information received from the communication device 100a.

The new communication device 100b controls operation performed therein based on the stored configuration information. For example, the communication device 100b may upload the measurement information acquired by the various sensors 170 at a timing determined in accordance with the configuration information. In addition, the communication device 100b may enable (turn on) some of the various sensors 170 (plurality of sensors) based on the configuration information.

After the configuration information has been applied to the new communication device 100b in the aforementioned manner, the configuration processor 325 maintains the configuration information applied to the new communication device 100b unchanged even when the first device operation is detected. Accordingly, it is possible to prevent unintentional change of the configuration information even when the orientation of the communication device 100b is unintentionally changed after the new communication device 100b has been installed.

However, there is a possibility that, after the configuration information has been applied to the new communication device 100b, the user may desire to change the configuration information. In one embodiment, the configuration processor 325 determines that the user desires to change the configuration information of the communication device 100b, in a case where the second device operation on the new communication device 100b is detected after the configuration information has been applied to the new communication device 100b. Subsequently, the configuration processor 325 starts a configuration change process of changing the configuration information applied to the communication device 100b.

Here, the second device operation is a different operation from the first device operation. The second device operation may be an operation of continuously adding an acceleration to the communication device 100b over a predetermined time period. For example, shaking the communication device 100b for a predetermined time period by the user results in an acceleration being continuously added to the communication device 100b.

The configuration processor 325 identifies the acceleration added to the communication device 100b by acquiring, via the communicator 310, the measurement information acquired by the sensor of the communication device 100b. Alternatively, the communication device 100b may detect that an acceleration has been continuously added, and the configuration processor 325 may acquire notification of the fact from the communication device 100b.

Alternatively, the second device operation may be an operation of pressing a predetermined button provided on the communication device 100b. However, the communication device such as a sensor device provided with poor user interface may have only a power button, for example. In such a case, it is preferred to select the operation of continuously adding an acceleration to the communication device 100b as the second device operation.

After the configuration change process of changing the configuration information applied to the communication device 100b has been started, the reference device selector 324 re-selects the reference device from among the candidate devices determined by the candidate determiner 322 based on the first device operation. Upon the reference device being re-selected, the configuration processor 325 performs a process of configuring, for the communication device 100b, the configuration information configured for the re-selected reference device.

### Example Operation of Device Management Apparatus

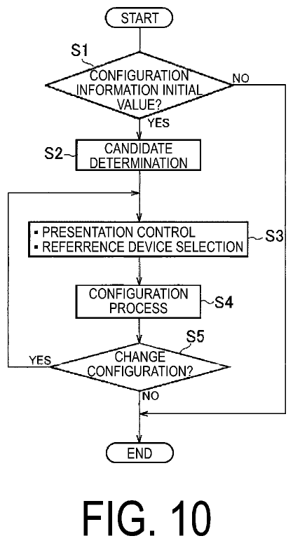

FIG. 10 illustrates an example operation of the device management apparatus 300 according to one embodiment.

As illustrated in FIG. 10, the initial value determiner 321 determines, at step S1, whether or not the configuration information applied to the communication device 100b is the initial value. When the configuration information applied to the communication device 100b is not the initial value (NO at step S1), the configuration information is prioritized. Alternatively, as will be described below, the configuration information of the installed communication device 100a may be configurable for the communication device 100b, even when configuration information other than the initial value has been applied.

In a case where the configuration information applied to the communication device 100b is the initial value (YES at step S1), the candidate determiner 322 determines, at step S2, candidate devices from among the installed communication devices 100a, based on the position information (first position information) of each of the installed communication devices 100a and the position information (second position information) of the communication device 100b.

At step S3, after candidate devices have been determined by the candidate determiner 322, the presentation controller 323 causes the candidate device supposed to be selected as the reference device to present the information. The reference device selector 324 selects a reference device from among candidate devices based on the first device operation performed on the communication device 100b.

At step S4, the configuration processor 325 performs a process of configuring, for the communication device 100b, the configuration information configured for the reference device selected by the reference device selector 324. The communication device 100b controls operation performed therein based on the stored configuration information.

At step S5, in a case where the second device operation performed on the communication device 100b has been detected, the configuration processor 325 starts a configuration change process (configuration change mode) of changing the configuration information applied to the communication device 100b. Upon the configuration change mode being started (YES at step S5), the process returns to step S3 (or step S2).

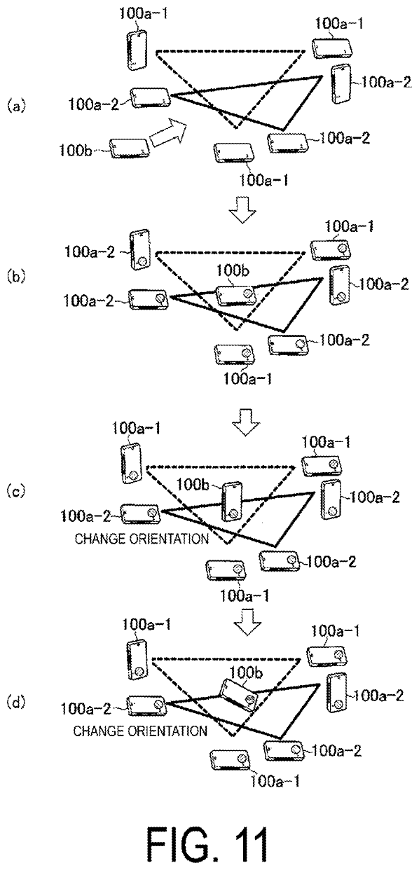

FIG. 11 illustrates a specific example of the device configuration operation according to one embodiment.

As illustrated in FIG. 11(a), there exist a plurality of installed communication devices 100a-1 (first device group) and a plurality of installed communication devices 100a-2 (second device group) configured differently from the communication devices 100a-1. Here, the communication device 100b, which is the configuration target device, is caused to move to an overlapping portion between a region formed by the communication devices 100a-1 and a region formed by the communication devices 100a-2. The candidate determiner 322 of the device management apparatus 300 determines the communication device 100a-1 as the first candidate device, and determines the communication device 100a-2 as the second candidate device.

As illustrated in FIG. 11(b), the presentation controller 323 of the device management apparatus 300 causes the communication device 100a-1 and the communication device 100b to display the first information indicating that the communication device 100a-1 is selected as the reference device. FIG. 11(b) illustrates an example in which the presentation controller 323 of the device management apparatus 300 causes the communication device 100a-1 and the communication device 100b to emit light of a same color. In addition, FIG. 11(b) illustrates an example in which the presentation controller 323 of the device management apparatus 300 causes the communication device 100a-2 to emit light of a different color.

As illustrated in FIG. 11(c), in a case where the orientation of the communication device 100b has been changed within a certain time period, the presentation controller 323 of the device management apparatus 300 causes the communication device 100a-2 and the communication device 100b to display second information indicating that the communication device 100a-2 is selected as the reference device. FIG. 11(c) illustrates an example in which the presentation controller 323 of the device management apparatus 300 causes the communication device 100a-2 and the communication device 100b to emit light of a same color.

As illustrated in FIG. 11(d), in a case where the orientation of the communication device 100b is further changed within a certain time period after the orientation of the communication device 100b has been changed in FIG. 11(c)), the presentation controller 323 of the device management apparatus 300 causes the communication device 100b to display third information indicating that the configuration information preliminarily applied to the communication device 100b is selected. The preliminarily applied configuration information may be the initial value, or may be any configuration information other than the initial value. FIG. 11(d) illustrates an example in which the presentation controller 323 of the device management apparatus 300 causes the communication device 100b to emit light of a color different from those of the communication devices 100a-1 and 100a-2.

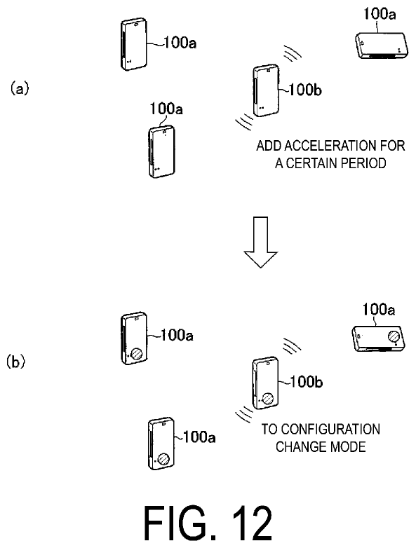

FIG. 12 illustrates a specific example of the configuration change operation according to one embodiment.

As illustrated in FIG. 12(a), the configuration processor 325 of the device management apparatus 300 detects that an acceleration has been continuously acting on the communication device 100b for a predetermined time period after the configuration information is configured for the communication device 100b.

As illustrated in FIG. 12(b), upon detecting that an acceleration has been continuously added to the communication device 100b for a predetermined time period, the configuration processor 325 of the device management apparatus 300 starts the configuration change mode of changing the configuration information applied to the communication device 100b.

### Example Change of System Configuration

In the example system configuration illustrated in FIG. 3, it has been assumed that the communication device 100b to be newly installed has preliminarily applied thereto the configuration information (network information) for performing wireless LAN communication. In a case where the network information has not been configured for the communication device 100b to be newly installed, the device management apparatus 300 may transmit the network information to the communication device 100b and configure the network information for the communication device 100b.

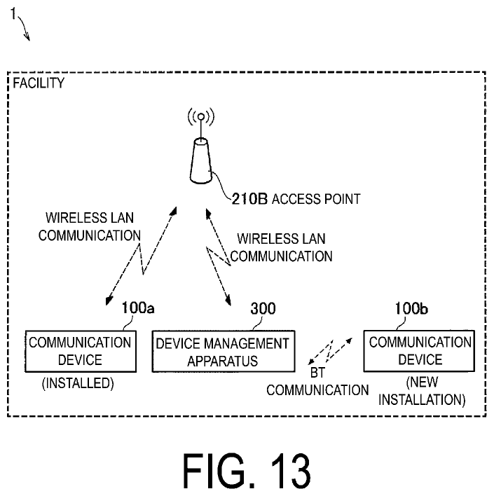

FIG. 13 illustrates an example modification of the system configuration illustrated in FIG. 3.

As illustrated in FIG. 13, the device management apparatus 300 receives, from the communication device 100a via the access point 210B, the first position information indicating the installation position of the installed communication device 100a. The device management apparatus 300 receives, from the communication device 100b via communication means other than wireless LAN communication such as BT, the second position information indicating the current position of the communication device 100b to be newly installed.

For example, the device management apparatus 300 determines whether or not the communication device 100b is located within a predetermined range from the installation position of the communication device 100a, based on the first and the second position information. Subsequently, upon that determining that the communication device 100b is located within a predetermined range from the installation position of the communication device 100a, the device management apparatus 300 transmits, to the communication device 100b, the same configuration information as the configuration information applied to the communication device 100a.

Here, the configuration information includes network information for configuring connection of wireless LAN communication. The network information includes, for example, identification information (SSID) of the access point 210B and an authentication code (password) for accessing the access point 210B.

Subsequently, the communication device 100b stores the configuration information (network information) received from the device management apparatus 300, and controls the operation on the communication device 100b based on the stored configuration information. Specifically, the communication device 100b configures connection to the access point 210B, based on the network information received from the device management apparatus 300.

### Other Embodiments

In the above-described embodiments, an example has been described in which the initial value determiner 321, the candidate determiner 322, the presentation controller 323, the reference device selector 324, and the configuration processor 325 are provided in the device management apparatus 300. However, some or all of the initial value determiner 321, the candidate determiner 322, the presentation controller 323, the reference device selector 324, and the configuration processor 325 may be provided in the communication device 100b.

Additionally, in a case where the communication device 100b has a sensor (geomagnetic sensor) configured to detect the orientation in the above-described embodiments, the reference device selector 324 may select a reference device from among candidate devices, based on the orientation to which the communication device 100b is directed as the orientation of the communication device 100b. Specifically, the reference device selector 324 may identify the orientation of each candidate device referring to the communication device 100b, based on the first and the second position information, and select the candidate device corresponding to the orientation to which the communication device 100b is directed as the reference device. On this occasion, the presentation controller 323 may cause the candidate devices to present information, the candidate devices corresponding to the orientation to which the communication device 100b is directed.

In addition, an example has been described in the above-described embodiment, in which the communication devices 100 are sensor devices having various sensors. However, the communication devices 100 are not limited to sensor devices, and may be any device having a communication function and installed at a certain position. For example, the communication devices 100 may be a home appliance having a communication function, a distributed power supply (power generation device or power storage device) having a communication function, and/or an industrial device having a communication function, or the like.

There may be provided a program that causes a computer to execute the processes performed by the communication device 100 or the device management apparatus 300. The program may be recorded in a computer readable medium. Use of a computer readable medium enables the program to be installed on a computer. Here, the computer readable medium on which the program is recorded may be a non-transitory recording medium. The non-transitory recording medium is not particularly limited, and may be, for example, a recording medium such as a CD-ROM, a DVD-ROM, or the like. In addition, functional units (circuits) configured to carry out the processes to be performed by the communication device 100 or the device management apparatus 300 may be integrated, whereby the communication device 100 or the device management apparatus 300 may be implemented as a semiconductor integrated circuit (chipset or SoC).

Embodiments have been described above in detail with reference to the drawings, but specific configurations are not limited to those described above, and various design modifications can be made without departing from the gist of the present disclosure.

The present application claims priority of Japanese Patent Application No. 2019-078024, filed on Apr. 16, 2019, the entirety of which being incorporated herein by reference.

1. A device management system comprising at least one processor to configure a configuration target device, wherein
the at least one processor is configured to perform:
a candidate determination process of determining, from among a plurality of installed devices, based on position information of each of the plurality of installed devices and position information of the configuration target device, a candidate device which is a candidate of a reference device to be referred to for configuring the configuration target device;
a reference device selection process of selecting the reference device from among a plurality of the candidate devices determined in the candidate determination process, based on a device operation on the configuration target device; and
a configuration process of configuring, for the configuration target device, configuration information configured for the reference device selected in the reference device selection process.

2. The device management system according to claim 1, wherein
the candidate determination process includes
a process of determining a installed device of the plurality of installed devices located closest to the configuration target device as a first candidate device, and
a process of determining a installed device of the plurality of installed devices, which is different from the first candidate device, as a second candidate device having a lower priority than the first candidate device.

3. The device management system according to claim 1, wherein
the candidate determination process includes
a process of determining, as a first candidate device, a installed device of the plurality of installed devices included in a first device group which forms a first region including a position of the configuration target device and in which a device of the first device group has a configuration identical to each other, and
a process of determining, as a second candidate device, a installed device of the plurality of installed devices included in a second device group which forms a second region including a position of the configuration target device and in which a device of the second device group has a configuration identical to each other, and
the first device group is a device group including a installed device of the plurality of installed devices located closest to the configuration target device.

4. The device management system according to claim 2, wherein
the at least one processor further performs a presentation control process of causing at least one of the first candidate device or the configuration target device to present first information indicating that the first candidate device is selected as the reference device, and
the reference device selection process includes a process of selecting the first candidate device as the reference device in a case where a first device operation is not detected within a certain time period after presentation of the first information is started.

5. The device management system according to claim 4, wherein
the configuration target device has a sensor configured to detect an orientation of the configuration target device itself, and
the first device operation is an operation for changing the orientation of the configuration target device.

6. The device management system according to claim 4, wherein
the presentation control process includes a process of causing at least one of the second candidate device or the configuration target device to present second information indicating that the second candidate device is selected as the reference device, in a case where the first device operation is detected within the certain time period, and
the reference device selection process includes a process of selecting the second candidate device as the reference device in a case where the first device operation is not detected within a certain time period after presentation of the second information is started.

7. The device management system according to claim 4, wherein
the configuration process includes a process of keeping the configuration information configured for the configuration target device unchanged in a case where the first device operation is detected after configuration information is configured for the configuration target device.

8. The device management system according to claim 7, wherein
the configuration process includes a process of starting a configuration change process of changing the configuration information configured for the configuration target device, in a case where a second device operation on the configuration target device is detected after the configuration information is configured for the configuration target device, and
the reference device selection process includes a process of re-selecting the reference device from among the plurality of the candidate devices, based on the first device operation after the configuration change process is started.

9. The device management system according to claim 8, wherein
the configuration target device has a sensor configured to detect an acceleration acting on the configuration target device itself, and
the second device operation is an operation of continuously causing an acceleration to act on the configuration target device for a predetermined time period.

10. The device management system according to claim 1, wherein the at least one processor further performs an initial value determination process of determining whether the configuration information configured for the configuration target device is an initial value, and
the reference device selection process includes a process of selecting the reference device from among the plurality of the candidate devices, in a case where the configuration information configured for the configuration target device is determined to be an initial value.

11. A device management apparatus configured to configure a configuration target device, the device management apparatus comprising:
a controller configured to perform
a candidate determination process of determining, from among a plurality of installed devices, based on position information of each of the plurality of installed devices and position information of the configuration target device, a candidate device which is a candidate of a reference device to be referred to for configuring the configuration target device;
a reference device selection process of selecting the reference device from among a plurality of the candidate devices determined in the candidate determination process, based on a device operation on the configuration target device; and
a configuration process of configuring, for the configuration target device, configuration information configured for the reference device selected in the reference device selection process.

12. A device management method for configuring a configuration target device, the method comprising:
determining, from among a plurality of installed devices, based on position information of each of the plurality of installed devices and position information of the configuration target device, a candidate device which is a candidate of a reference device to be referred to for configuring the configuration target device;
selecting the reference device from among a plurality of the candidate devices determined, based on a device operation on the configuration target device; and
performing a process of configuring, for the configuration target device, configuration information configured for the selected reference device.

13. A device management program that causes a computer to perform the device management method according to claim 12.
